(19) United States
(12) Patent Application Publication
(10) Pub. No.: US 2025/0358329 A1
(43) Pub. Date: Nov. 20, 2025

(54) REAL TIME NETWORK ANALYSIS FOR HEAD-MOUNTED DISPLAY

(71) Applicant: Meta Platforms Technologies, LLC, Menlo Park, CA (US)

(72) Inventor: Pranav Saxena, Sunnyvale, CA (US)

(21) Appl. No.: 19/025,444

(22) Filed: Jan. 16, 2025

Related U.S. Application Data
(60) Provisional application No. 63/647,708, filed on May 15, 2024.

(51) Int. Cl. G02B 27/01; H04L 65/80

(52) U.S. Cl. CPC G02B 27/0172; H04L 65/80

(57) ABSTRACT

An apparatus including a head-mount device (HMD) to execute a plurality of applications and processes, and a network-quality testing architecture to dynamically adjust an HMD-user's experience based on a real-time network condition. The network-quality testing architecture includes an edge server, and the edge server is in communication with a streaming client of a co-located server.

### CROSS-REFERENCE TO RELATED APPLICATIONS

The present disclosure is related and claims priority under 35 USC § 119 (e) to U.S. Provisional Application No. 63/647,708, entitled “REAL TIME NETWORK ANALYSIS FOR HEAD MOUNTED DISPLAY,” filed on May 15, 2024, the contents of which are herein incorporated by reference, in their entirety, for all purposes.

### TECHNICAL FIELD

The present disclosure generally relates to mixed reality (MR) and more particularly, to real-time network analysis for a head-mounted display.

### BACKGROUND

Head mounted displays (HMDs) offer users immersive experiences through virtual reality, augmented reality, and mixed reality applications. However, these applications demand significant computational power, often surpassing the processing capabilities of the devices themselves. Additionally, HMDs face constraints related to power consumption and thermal management. To address these challenges, a considerable portion of the computational workload can be offloaded to graphical processing units (GPUs) located on remote servers, such as those in data centers or the cloud. This offloading process, however, necessitates a stable and high-speed network connection to ensure an optimal user experience.

For instance, in a 3D virtual-reality (VR) streaming scenario, where compute-intensive artificial intelligence/machine-learning (AI/ML) algorithms are executed on a nearby server, specific network requirements must be met. These requirements include a certain downlink bitrate (e.g., of at least 25 Mbps), a certain uplink bitrate (e.g., of 5 Mbps), and a highest round-trip time (RTT) (e.g., less than 25 milliseconds). Without meeting these network performance metrics, the compute offload technology for HMDs would fail to deliver a reliable and low-latency experience, thereby compromising the overall functionality and user satisfaction.

### SUMMARY

According to some aspects, an apparatus of the subject technology includes a head-mount device (HMD) to execute a plurality of applications and processes, and a network-quality testing architecture to dynamically adjust an HMD-user's experience based on a real-time network condition. The network-quality testing architecture includes an edge server, and the edge server is in communication with a streaming client of a co-located server.

According to other aspects, a system of the subject technology includes an HMD in communication with a data center, a co-located server including a VM in communication with the data center and a streaming server, and an edge server configured to be in communication with the streaming server of the co-located server. The HMD includes a network speed-test service and a streaming client to work with the edge server to dynamically adjust an HMD-user's experience.

According to yet other aspects, a method of the subject technology includes initiating, by an HMD, an edge-discovery call to a core data center and receiving, by the HMD, an encrypted token including an internet protocol (IP) and port information of a selected edge server from the core data center. The method further includes conducting, by an RTNA client of the HMD, a speed test by using the selected edge server.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram illustrating an example of a network architecture within which some aspects of the subject technology is implemented.

FIG. 2 is a block diagram illustrating details of an example system for network quality testing, according to some embodiments.

FIG. 3 is a block diagram illustrating an example of a system for real-time network analysis, according to some aspects of the subject technology.

FIG. 4 is a flow diagram illustrating an example of a workflow for an edge-discovery process and speed test and network-quality assessment, according to some aspects of the subject technology.

FIG. 5 is a flow diagram illustrating an example of a workflow for connection establishment and data flow, according to some aspects of the subject technology.

FIG. 6 is a block diagram illustrating an exemplary computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to embodiments of the disclosed technology and may include or be implemented in conjunction with an artificial reality system. The term “artificial reality” as used herein may refer, according to some embodiments, to a perceptual reality that has been adjusted in some manner before presentation to a user, which may include, e.g., virtual reality (VR), augmented reality (AR), mixed reality (MR), extended reality, extra reality (XR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. An artificial reality system that provides the artificial reality content may be implemented on various platforms, which include some or all of a head mounted display (equivalently referred to as an HMD or a “headset”) connected to a host computer system, a standalone HMD, a mobile device or computing system, a “cave” environment or other projection system, or any other hardware platform capable of providing artificial reality content to one or more viewers.

The term “mixed reality” as used herein, refers, according to some embodiments, to systems where light entering a user's eye is partially generated by a computing system and partially composes light reflected off objects in the real world. For example, an MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see.

The term “virtual reality” as used herein, refers, according to some embodiments, to an immersive experience where a user's visual input is at least partially controlled by a computing system. Virtual reality may include, but is not limited to, augmented reality and mixed reality.

The term “augmented reality” as used herein, refers, according to some embodiments, to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects.

Embodiments of the present disclosure address the above identified problems such as failing to deliver a reliable and low-latency user experience due to not meeting the network performance metrics, which can compromise the overall functionality and user satisfaction. The subject technology optimizes the network quality for MR/VR/AR headsets by dynamically adjusting data flow based on real-time network conditions. This involves a combination of client-side and server-side components working together to ensure a seamless user experience. The disclosed technology uses a real-time network analysis (RTNA) test triggered natively from the headset. The RTNA test may be performed at regular intervals, for example via a background daemon process which runs on the headset. The RTNA test may be an end-to-end (e2e) test between the headset process and a server-based process, executing on a server such as an edge server or a point-of-presence (POP) server, which also provides a computing offload technology for user applications executing on the headset.

Some embodiments provide: (1) a client-side networking speed-test daemon integrated in the virtual reality operating system on the headset, which can trigger the networking test at various defined intervals of time, and connect to a speed-test server deployed on edge servers, and (2) a speed-test server that can generate real-time metrics such as bitrate numbers, RTT, jitter values, inter-arrival packet times, etc., which can provide an accurate real-time view of the user's network.

In some embodiments, the RTNA test is performed by a networking client process on the HMD, which discovers a nearest edge/POP server which has a speed test server running, sends probes of packets for an uplink test, and starts receiving probes of packets for the downlink test. The packet size of the uplink and downlink probes may be configured to be any suitable size, based on various factors including operating system, current active application, geography, and the like. The server may know the timestamps of each packet and generate metrics such as round-trip time (RTT).

In some embodiments, the RTNA test generates metrics for uplink and/or downlink testing. The metrics include, but are not limited to, packets expected/packets arrived and/or packet-loss rate, RTT, which can be based on a quick user-datagram protocol (UDP) internet connections (QUIC) transport, ping metrics, bitrate, jitter, inter-arrival packet times, and Wi-Fi telemetry, including Wi-Fi band (e.g., 2 GHZ, 5 GHZ, etc.), a received-signal strength-indicator (RSSI) index, and a service server identifier (SSID).

In some embodiments, telemetry may be logged to a storage service such as an operational data store (ODS). The logs may be analyzed for reports on user engagement, user network quality maps, and the like. In some embodiments, core network speed test functionality may be integrated into a streaming client at a native layer. Native application program interfaces (APIs) may be directly called into for triggering the speed test from HMDs.

In some embodiments, the RTNA test may be triggered from a user interface that calls a native network speed test layer via Java native interface (JNI) bindings. The service may be launched from an application, and the service may bind to it and gracefully shut down (unbind) when the test is done. In some embodiments, the RTNA test may be tailored to the user experience. This may include low-latency real-time experiences (Edge, POPs, and colocation deployment). The architecture may be extended to near real-time experiences and open it to data center-based streaming for use cases like cloud mixed-reality.

In some embodiments, Wi-Fi-related telemetry may be integrated into the RTNA test. This may help inform which Wi-Fi band a user is connected to inform corrective measures provided to the user in order to improve the user experience.

Some embodiments integrate real-time network bandwidth numbers from the RTNA test. Users may be targeted based on their location, closer to edge/POP/co-located servers in order to serve a better user interface to users for cloud powered experiences.

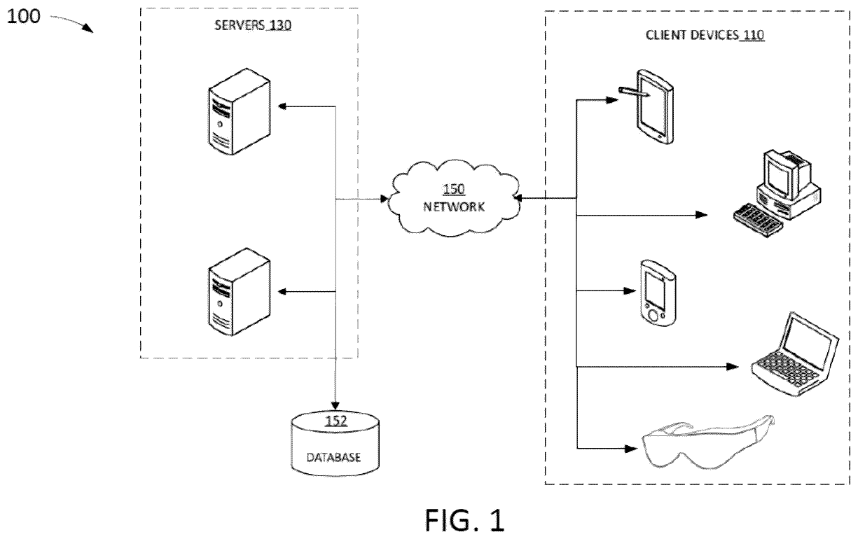

Returning now to figures, FIG. 1 is a block diagram illustrating an example of a network architecture within which some aspects of the subject technology is implemented. The network architecture 100 may include one or more servers 130 and a database 152, communicatively coupled with one or more client devices 110 via a network 150. The network 150 may include a wired network (e.g., via fiber optic or copper wire, telephone lines, and the like) and/or a wireless network (e.g., a satellite network, a cellular network, radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, a laptop computer, a desktop computer, or a mobile device such as a smart phone, a palm device, a tablet device, a television, a wearable device, a display device, and/or the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be a computing device such as part of a cloud computing server including one or more desktop computers or panels mounted on racks, and/or the like. The panels may include processing boards and also switchboards, routers, and other network devices. In some embodiments, the servers 130 may include the client devices 110 as well, such that they are peers.

One or more of servers 130 may be communicatively coupled to a database 152. Database 152 may store data and files associated with the servers 130 and/or the client devices 110. In some embodiments, client devices 110 collect data, including but not limited to video and images, for upload to servers 130, to store in the database 152.

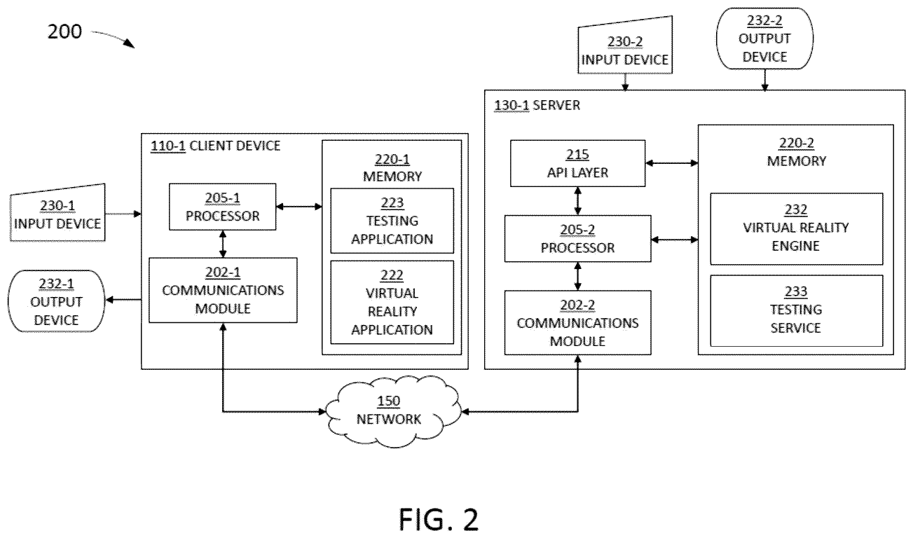

FIG. 2 is a block diagram illustrating details of an example system 200 for network quality testing, according to some embodiments. Specifically, the example of FIG. 2 illustrates an exemplary client device 110-1 (of the client devices 110) and an exemplary server 130-1 (of the servers 130) of the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, uploads, messages, and commands to other devices on the network 150. Communications modules 202 can be, for example, modems or Ethernet cards, and may include radio hardware and software for wireless communications (e.g., via electromagnetic radiation, such as radiofrequency (RF), near field communications (NFC), Wi-Fi, and Bluetooth radio technology).

The client devices 110-1 and server 130-1 each also include a processor 205-1, 205-2 and memory 220-1, 220-2, respectively. Processors 205-1 and 205-2, and memories 220-1 and 220-2 will be collectively referred to, hereinafter, as “processors 205” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touchscreen display, and the like. In some embodiments, the input devices 230 may include cameras, microphones, and sensors, such as touch sensors, acoustic sensors, inertial motion units and other sensors configured to provide input data to a VR/AR headset.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include a virtual reality application 222, configured to run in client device 110-1 and couple with input device 230-1 and output device 232-1. The virtual reality application 222 may be downloaded by the user from server 130-1, and/or may be hosted by server 130-1. The virtual reality application 222 may include specific instructions which, when executed by processor 205-1, cause operations to be performed consistent with embodiments of the present disclosure. In some embodiments, the virtual reality application 222 runs on an operating system (OS) installed in client device 110-1. In some embodiments, virtual reality application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes a virtual reality engine 232. The virtual reality engine 232 may be configured to perform methods and operations consistent with embodiments of the present disclosure. The virtual reality engine 232 may share or provide features and resources with the client device, including data, libraries, and/or applications retrieved with virtual reality engine 232 (e.g., virtual reality application 222). The user may access the virtual reality engine 232 through the virtual reality application 222, installed in a memory 220-1 of client device 110-1. Accordingly, virtual reality application 222 may be installed in client device 110-1 by server 130-1 and perform scripts and other routines provided by server 130-1.

Memory 220-1 may further include a testing application 223, configured to execute in client device 110-1. The testing application 223 may communicate with testing service 233 in memory 220-2 to provide real-time network analysis and testing. The testing application 223 may communicate with testing service 233 through API layer 215, for example.

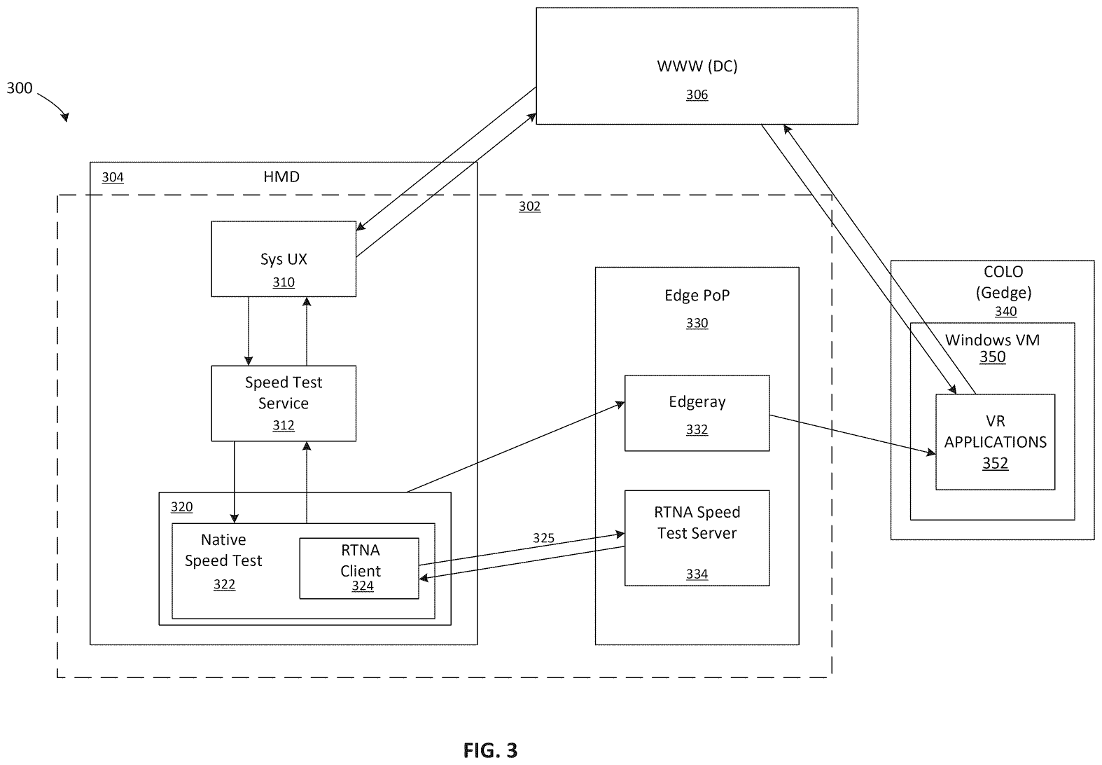

FIG. 3 is a block diagram illustrating an example of a system 300 for real-time network analysis, according to some aspects of the subject technology. The system 300 includes a network quality testing architecture 302, which in turn includes a portion of an HMD 304, and a point-of-presence (POP) edge server 330 (hereinafter, edge server 330). The system 300 also includes a world-wide web (WWW) data center 306 (hereinafter, core data center 306) hosting multiple server-side endpoints, and at least one other co-located (COLO) server 340, for example, a gaming edge (Gedge) server. The edge server 330 and the COLO server 340 reduce latency by being geographically closer to the user and act as intermediaries between the HMD 304 and the core data center 306, which handles the main computational tasks and stores the bulk of the data.

The HMD 304 executes a number of applications and/or processes, including a system user experience (UX) process 310, a speed test service 312 (e.g., a network speed test service), and an extended reality (XR) streaming client 320. In this example, the system UX process 310 launches the speed test service 312, and the XR streaming client 320 communicates with the speed test service 312 through Java native interface (JNI) bindings, which allows communication between Java and other languages. The XR streaming client 320 consists of a native speed-test process 322, which includes an RTNA client 324.

The Edge server 330 is one of multiple such servers that are geographically distributed. For a user's given location, the nearest such Edge server 330 is determined to establish a connection from the XR streaming client 320. The Edge server 330 executes a cloud-computing process (e.g., Edgeray) 332 (hereinafter, process 332), which functions as a proxy between the HMD 304 and the edge server 330. The process 332 is in communication with an XR streaming client of the VR Applications 352 and facilitates offloading expensive computation from the XR streaming client 320 to a Windows virtual machine (VM) 350 executing on the COLO server 340. The edge server 330 also executes an RTNA speed test server 334 that communicates with the RTNA client 324, over a connection 325 (e.g., a QUIC connection). The RTNA speed test server 334 communicates with the native speed test process 322, and more specifically, with the RTNA client 324.

The speed test service 312 runs a speed-test service to monitor actual network connection quality and communicates with servers to optimize data flow. The speed test service 312 may be scheduled to run at periodic intervals, or be triggered by a change in environment, such as a change of SSID. If the native speed test process 322 detects any degradation of metrics that are critical to the operation of the XR streaming client 320, then feedback is provided to the user via the system UX process 310 so that the user may troubleshoot the reason for the degradation. Specific solutions may also be provided to the user as suggestions for resolving the problem, such as moving closer to a router, reducing the number of applications accessing the local network, moving to a different geographic location, and the like.

In some implementations, the subject technology can deploy MR/VR/AR applications on demand based on user requests and network conditions, as measured by the system 300. This ensures efficient use of resources and reduces latency. The COLO server 340 manages the allocation of computational resources, such as graphical processing units (GPUs), based on the specific requirements of the MR/VR/AR applications.

In some implementations, the subject technology may include the ability to dynamically adjust the MR/VR/AR experience based on real-time network conditions. In some implementations, the speed test service 312 could run in the background at regular intervals to continuously monitor network quality and preemptively adjust the experience.

In summary, the network quality testing architecture 302 discussed above provides a robust framework for optimizing network quality for MR/VR/AR headsets. By leveraging edge computing, dynamic resource allocation, and strong security measures, the system aims to deliver a seamless and high-quality user experience.

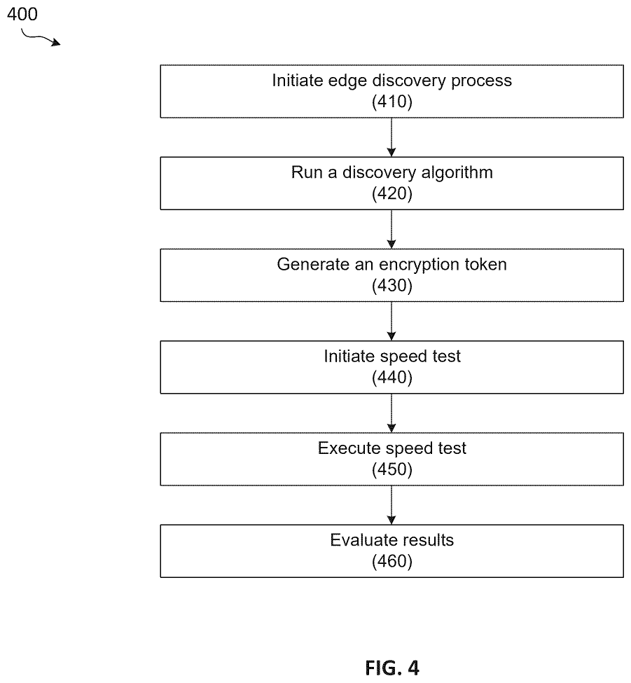

FIG. 4 is a flow diagram illustrating an example of a workflow for an edge-discovery process 400 and speed test and network-quality assessment, according to some aspects of the subject technology. The edge-discovery process 400 includes process steps 410 to 460.

In process step 410, the System UX (e.g., 310 of FIG. 3) or an Android package kit (APK) on the headset (e.g., HMD 304 of FIG. 3) initiates an edge discovery call to the core data center (e.g., 306 of FIG. 3).

In process step 420, the core data center 306 runs an algorithm to determine the best edge POP (e.g., edge server 330) and a COLO server (e.g., 340 of FIG. 3) based on various factors such as latency, GPU requirements, and network bandwidth.

In process step 430, the core data center 306 returns an encrypted token to the system UX 310, which includes the IP and port information of the selected edge sever 330 and the COLO server 340.

In process step 440, the System UX 310 passes the token to the speed test service 312, which then instructs the RTNA client (e.g., 324 of FIG. 3) to conduct a speed test using the edge server 330.

In process step 450, the edge server 330 uses the RTNA client 324 to perform uplink and downlink tests to assess the network quality.

In process step 460, the RTNA client 324 receives the test results and determines whether the network conditions meet the criteria for the desired MR/VR/AR experience.

The subject technology includes security features including acting by the edge server 330 as a proxy to protect the core server (e.g., 306 of FIG. 3) from direct access, preventing potential attacks such as distributed denial of service (DDoS) and man-in-the-middle attacks. Further, the use of encrypted tokens ensures that only authorized clients can connect to the core servers.

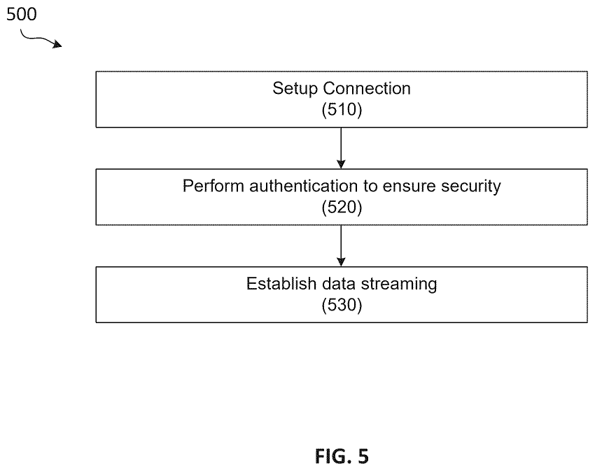

FIG. 5 is a flow diagram illustrating an example of a workflow for a connection establishment and data-flow process 500, according to some aspects of the subject technology. The connection establishment and data-flow process includes process steps 510 to 530.

In process step 510, if the network conditions are satisfactory, based on step 460 of FIG. 4, the XR streaming client (e.g., 320 of FIG. 3) on the headset establishes a connection with the XR streaming application on the COLO server (e.g., 340 of FIG. 3) via the edge server (e.g., 330 of FIG. 3).

In process step 520, the edge server 330 performs an authentication process using the encrypted token, of step 430 of FIG. 4, to ensure the connection is secure and authorized. If successful, the edge server 330 relays the traffic to the COLO server 340.

In process step 530, the XR streaming client 320 and the XR streaming application on the COLO server 340 establish a bidirectional data flow, enabling the MR/VR/AR experience.

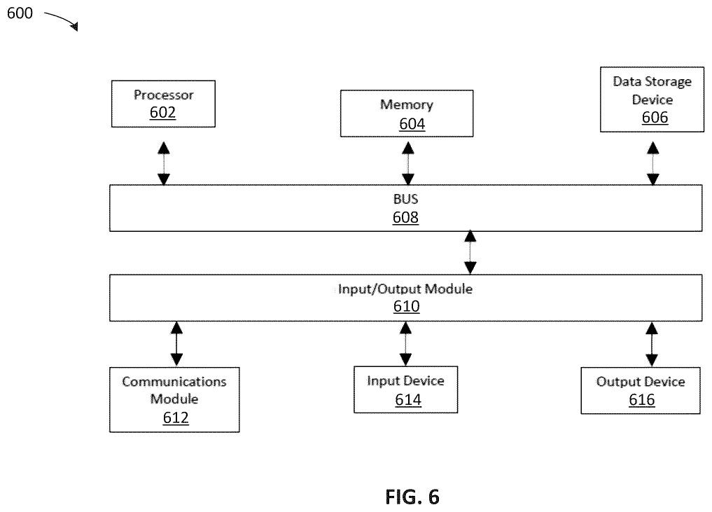

FIG. 6 is a block diagram illustrating an exemplary computer system with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described system 300 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads application data and provides an application, information may be read from the application data and stored in a memory device, such as the memory 604. Additionally, data from the memory 604 servers accessed via a network, the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

An aspect of the subject technology is directed to an apparatus that includes a head-mount device (HMD) to execute a plurality of applications and processes, and a network-quality testing architecture to dynamically adjust an HMD-user's experience based on a real-time network condition. The network-quality testing architecture includes an edge server, and the edge server is in communication with a streaming client of a co-located server.

In some implementations, the plurality of applications and processes comprise a user-experience (UX) process, a network speed test service and a streaming client of the HMD.

In one or more implementations, the UX process is configured to launch the network speed test service via communication with the streaming client.

In some implementations, the network speed test service is configured to monitor an actual network connection quality and communicate via the streaming client with the edge server to increase data flow.

In one or more implementations, the network speed test service is configured to be scheduled to run at periodic intervals or be triggered by a change in an environment including a change of a service-server identification (SSID).

In some implementations, the edge server is configured to execute a cloud-computing process that is configured to function as a proxy between the edge server and the HMD.

In one or more implementations, the cloud-computing process is configured to facilitate offloading computation from the streaming client to a virtual machine (VM) executing on the co-located server.

In some implementations, the edge server is further configured to execute a real-time network analysis (RTNA) speed test server.

In one or more implementations, the RTNA speed test server is configured to communicate with an RTNA client of the streaming client.

In some implementations, the streaming client includes a native speed-test process configured to detect any degradation of metrics that are related to an operation of the streaming client.

In one or more implementations, the streaming client is configured to provide feedback to a user via a UX process to allow the user to troubleshoot reasons for the detected degradation.

Another aspect of the subject technology is directed to a system that includes an HMD in communication with a data center, a co-located server including a VM in communication with the data center and a streaming server, and an edge server configured to be in communication with the streaming server of the co-located server. The HMD includes a network speed-test service and a streaming client to work with the edge server to dynamically adjust an HMD-user's experience.

In some implementations, the HMD-user's experience is adjusted based on a real-time network condition including any degradation of metrics that are related to an operation of a streaming client of the HMD.

In one or more implementations, the edge server is configured to execute a cloud-computing process to facilitate offloading computation from the streaming client to the VM for execution on the co-located server.

In some implementations, the HMD is configured to execute a plurality of applications and processes comprising a UX process, the network speed-test service and the streaming client.

In one or more implementations, the edge server is further configured to execute an RTNA speed test server configured to communicate with an RTNA client of the streaming client.

In some implementations, the streaming client includes a native speed-test process configured to detect any degradation of metrics that are related to an operation of the streaming client and to provide feedback to a user via a UX process to allow the user to troubleshoot reasons for the detected degradation.

Yet another aspect of the subject technology is directed to a method that includes initiating, by an HMD, an edge-discovery call to a core data center and receiving, by the HMD, an encrypted token including an internet protocol (IP) and port information of a selected edge server from the core data center. The method further includes conducting, by an RTNA client of the HMD, a speed test by using the selected edge server.

In one or more implementations, the method further comprises causing the selected edge server to perform uplink and downlink tests to assess a network quality, and determining, based on test results, whether the network conditions meet criterion for a desired user experience.

In some implementations, the method further includes initiating the edge-discovery call performed by a system UX of the HMD; receiving, from the core data center, another encrypted token associated with a co-located server, and the encrypted token and the other encrypted token are determined based on a plurality of factors including latency, graphical processing unit (GPU) requirements, and network bandwidth.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
a head-mount device (HMD) configured to execute a plurality of applications and processes; and
a network-quality testing architecture configured to dynamically adjust an HMD-user's experience based on a real-time network condition,
wherein:
the network-quality testing architecture includes an edge server, and
the edge server is in communication with a streaming client of a co-located server.

2. The apparatus of claim 1, wherein the plurality of applications and processes comprise a user-experience (UX) process, a network speed test service and a streaming client of the HMD.

3. The apparatus of claim 2, wherein the UX process is configured to launch the network speed test service via communication with the streaming client.

4. The apparatus of claim 2, wherein the network speed test service is configured to monitor an actual network connection quality and communicate via the streaming client with the edge server to increase data flow.

5. The apparatus of claim 2, wherein the network speed test service is configured to be scheduled to run at periodic intervals or be triggered by a change in an environment including a change of a service-server identification (SSID).

6. The apparatus of claim 1, wherein the edge server is configured to execute a cloud-computing process that is configured to function as a proxy between the edge server and the HMD.

7. The apparatus of claim 6, wherein the cloud-computing process is configured to facilitate offloading computation from the streaming client to a virtual machine (VM) executing on the co-located server.

8. The apparatus of claim 1, wherein the edge server is further configured to execute a real-time network analysis (RTNA) speed test server.

9. The apparatus of claim 8, wherein the RTNA speed test server is configured to communicate with an RTNA client of the streaming client.

10. The apparatus of claim 8, wherein the streaming client includes a native speed-test process configured to detect any degradation of metrics that are related to an operation of the streaming client.

11. The apparatus of claim 10, wherein the streaming client is configured to provide feedback to a user via a UX process to allow the user to troubleshoot reasons for the detected degradation.

12. A system, comprising:
an HMD in communication with a data center;
a co-located server including a VM in communication with the data center and a streaming server; and
an edge server configured to be in communication with the streaming server of the co-located server,
wherein the HMD includes a network speed-test service and a streaming client configured to work with the edge server to dynamically adjust an HMD-user's experience.

13. The system of claim 12, wherein the HMD-user's experience is adjusted based on a real-time network condition including any degradation of metrics that are related to an operation of a streaming client of the HMD.

14. The system of claim 13, wherein the edge server is configured to execute a cloud-computing process to facilitate offloading computation from the streaming client to the VM for execution on the co-located server.

15. The system of claim 14, wherein the HMD is configured to execute a plurality of applications and processes comprising a UX process, the network speed-test service and the streaming client.

16. The system of claim 14, wherein the edge server is further configured to execute an RTNA speed test server configured to communicate with an RTNA client of the streaming client.

17. The system of claim 12, wherein the streaming client includes a native speed-test process configured to detect any degradation of metrics that are related to an operation of the streaming client and to provide feedback to a user via a UX process to allow the user to troubleshoot reasons for the detected degradation.

18. A method, comprising:
initiating, by an HMD, an edge-discovery call to a core data center;
receiving, by the HMD, an encrypted token including an internet protocol (IP) and port information of a selected edge server from the core data center; and
conducting, by an RTNA client of the HMD, a speed test by using the selected edge server.

19. The method of claim 18, further comprising:
causing the selected edge server to perform uplink and downlink tests to assess a network quality; and
determining, based on test results, whether the network conditions meet criterion for a desired user experience.

20. The method of claim 18, wherein,
initiating the edge-discovery call is performed by a system UX of the HMD;
receiving, from the core data center, another encrypted token associated with a co-located server; and
the encrypted token and the other encrypted token are determined based on a plurality of factors including latency, graphical processing unit (GPU) requirements, and network bandwidth.
